(19) United States
(12) Patent Application Publication
(10) Pub. No.: US 2011/0053466 A1
(43) Pub. Date: Mar. 3, 2011

(54) GLASS SUBSTRATE SPACER SEPARATING SYSTEM AND GLASS SUBSTRATE FABRICATING METHOD

(75) Inventors: Tomohiro HOSHINO, Tokyo (JP); Takeshi MIYAWAKI, Tokyo (JP); Haruo WATANABE, Tokyo (JP)

(73) Assignee: Asahi Glass Company, Limited, Tokyo (JP)

(21) Appl. No.: 12/870,308

(22) Filed: Aug. 27, 2010

(30) Foreign Application Priority Data
Aug. 28, 2009 (JP) 2009-198271

(51) Int. Cl. B24B 1/00; B32B 38/10

(52) U.S. Cl. 451/44; 156/584

(57) ABSTRACT

A glass substrate spacer separating apparatus includes: a cassette adapted to load a plurality of glass substrates with spacers attached thereto in such a state that the plurality of glass substrates are separated piece by piece; a liquid tank adapted to store a liquid in which the cassette is to be submerged; and a bubble generating mechanism configured to generate bubbles which move towards an interior of the cassette which is submerged in the liquid of the liquid tank, wherein the spacers are separated individually from the plurality of glass substrates to which the spacers are attached by bringing the bubbles generated from the bubble generating mechanism into contact with surfaces of the plurality of glass substrates with spacers attached thereto which are loaded in the cassette in the liquid of the liquid tank.

### BACKGROUND

1. Field of the Invention

The present invention relates to a glass substrate spacer separating apparatus for separating spacers adhering to main planes of glass substrates from the glass substrates and a glass substrate manufacturing method.

2. Description of the Related Art

For example, in a manufacturing process for manufacturing circular disc-shaped glass substrates, there is a machining process of machining planes and end faces of glass substrates including a grinding or abrasion step. For example, as a method for enhancing the abrasion efficiency of end faces of glass substrates, there is used a method comprising steps of preparing a stacked body of glass substrates in which a plurality of (for example, some several hundreds) glass substrates are stacked one on another via resin spacers in a plane direction and grinding or abrading end faces of so many glass substrates at the same time.

On completion of the machining of the end faces of the stacked body of glass substrates, a spacer separating and glass substrate loading work needs to be performed before the glass substrates are transported to a subsequent step of grinding or abrading plane portions of the glass substrates. In the spacer separating and glass substrate loading work, glass substrates are separated piece by piece from the stacked body of glass substrates, and further, spacers are separated from the glass substrates. Then, resultant spacer-free glass substrates are loaded in a predetermined cassette. This step of separating the glass substrates piece by piece from the stacked body of glass substrates for loading in the cassette has been mainly implemented by the hands of workers.

However, in the manual separation approach, the planes of the glass substrates are pressed against by one another, and therefore, the spacers cannot easily be separated from the glass substrates, leading to a problem that many labor hours have to be involved in the approach.

Then, as methods for separating glass substrates piece by piece from a stacked body of glass substrates and removing spaces from the glass substrates so separated, there have conventionally been proposed approaches. For example, in one approach, with a stacked body of glass substrates submerged in a liquid of a tank, upper planes of glass substrates are sucked by a jig such as a vacuum sucking pad so as to be separated from one another, and at the same time, a water pressure is applied to the stacked body of glass substrates so as to remove spacers from the glass substrates, as disclosed in JP-A-2008-302448. In the other approach, an arm is used which grips on an end face of a glass substrate at a plurality of portions (at least three portions), and the arm is raised while applying a flow of water, a brush and ultrasonic waves to the glass substrate so gripped so that a spacer is removed from the glass substrate at the same time as the glass substrate is separated from a stacked body of glass substrates, as disclosed in JP-A-2008-307612, JP-A-2009-48735 and JP-A-2009-48688.

In the methods for separating the spacers from the glass substrates by use of the conventional approaches, however, since the spacers closely attached to the main planes of the glass substrates are separated piece by piece from the glass substrates in a secured fashion, it takes time in separating the spacers, leading to a problem that the production efficiency is lowered.

### SUMMARY

In view of these situations, an object of the invention is to provide a glass substrate spacer separating apparatus which solves the aforesaid problem and a glass substrate manufacturing method.

According to the invention, there is provided a glass substrate spacer separating apparatus including: a cassette adapted to load a plurality of glass substrates with spacers attached thereto in such a state that the plurality of glass substrates are separated piece by piece; a liquid tank adapted to store a liquid in which the cassette is to be submerged; and a bubble generating mechanism configured to generate bubbles which move towards an interior of the cassette which is submerged in the liquid of the liquid tank, wherein the spacers are separated individually from the plurality of glass substrates to which the spacers are attached by bringing the bubbles generated from the bubble generating mechanism into contact with surfaces of the plurality of glass substrates with spacers attached thereto which are loaded in the cassette in the liquid of the liquid tank

The liquid tank may include a moving mechanism for moving the cassette so as to change a relative position of the cassette to the bubble generating mechanism.

The bubble generating mechanism may include: a bubble generating unit which is provided at a bottom portion of the liquid tank and in which a plurality of holes are provided for generating bubbles in the liquid; a compressed gas source which is provided outside of the liquid tank, the compressed gas source being configured to supply a compressed gas to the bubble generating unit; a pressure regulator valve configured to regulate a pressure of the compressed gas supplied from the compressed gas supply source to a predetermined pressure; and a connection pipe configured to supply the compressed gas whose pressure is regulated by the pressure regulator valve to the bubble generating unit.

The bubble generating unit may include a plurality of holes whose opening diameter ranges from 0.2 mm to 2.0 mm on a surface of a tube or a flat plate.

The holes may be formed at intervals which are 0.2 to 2 times larger than glass substrate loading intervals at which the glass substrates with spacers attached thereto are loaded in the cassette in such a state that the glass substrates with spacers attached thereto are separated piece by piece.

The glass substrate spacer separating apparatus may further includes: a separate liquid tank provided inside or outside the liquid tank, the separate liquid tank being configured to collect the spacers separated from the glass substrates in the liquid tank; and a liquid supply mechanism configured to supply a liquid so that the liquid of the liquid tank overflows into the separate liquid tank.

The spacers separated in the liquid tank may be caused to move into the separate liquid tank together with the liquid which overflows from the liquid tank for collecting thereof.

The liquid tank may include an ultrasonic wave radiating mechanism configured to radiate ultrasonic waves to the glass substrates with spacers attached thereto which are loaded in the cassette which is submerged in the liquid.

According to another aspect of the invention, there is provided a glass substrate manufacturing method including: preparing a stacked body of glass substrates in which pluralities of glass substrates and spacers are stacked alternately one on another and abrading peripheral end surfaces of the glass substrates of the stacked body of glass substrates; separating the glass substrates from the stacked body of glass substrates after the abrasion of the peripheral end surface of the glass substrates has been performed; and separating the spacers adhering to main planes of the glass substrates from the glass substrates, wherein the glass substrate spacer separating apparatus set forth under any of the above is used to separate the spacers from the glass substrates in the separating of the spacers.

The spacers may be formed of a material whose specific gravity is lighter than that of the liquid stored in the liquid tank.

The glass substrates maybe glass substrates for magnetic recording media.

According to the invention, the spacers can be separated individually from the plurality of glass substrates to which the spacers are attached for collecting thereof with good efficiency by bringing the bubbles generated from the bubble generating mechanism into contact with the surfaces of the plurality of glass substrates with spacers attached thereto which are loaded in the cassette in the liquid of the liquid tank.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a schematic sectional view showing the configuration of an embodiment of a glass substrate spacer separating apparatus according to the invention;

FIG. 2 is a plan view of the glass substrate spacer separating apparatus shown in FIG. 1;

FIG. 3 is a vertical sectional view, as viewed sideways, of a liquid tank showing an interior configuration thereof;

FIG. 4 is a vertical sectional view, as viewed from the front, of an interior of a cassette;

FIG. 5 is a schematic sectional view showing the configuration of Modified Example 1 of a glass substrate spacer separating apparatus according to the invention;

FIG. 6 is a plan view of the glass substrate spacer separating apparatus shown in FIG. 5;

FIG. 7 is a schematic sectional view showing the configuration of Modified Example 2 of a glass substrate spacer separating apparatus according to the invention; and

FIG. 8 is a plan view of the glass substrate spacer separating apparatus shown in FIG. 7.

### DETAILED DESCRIPTION OF THE INVENTION

Hereinafter, a mode for carrying out the invention will be described by reference to the drawings.

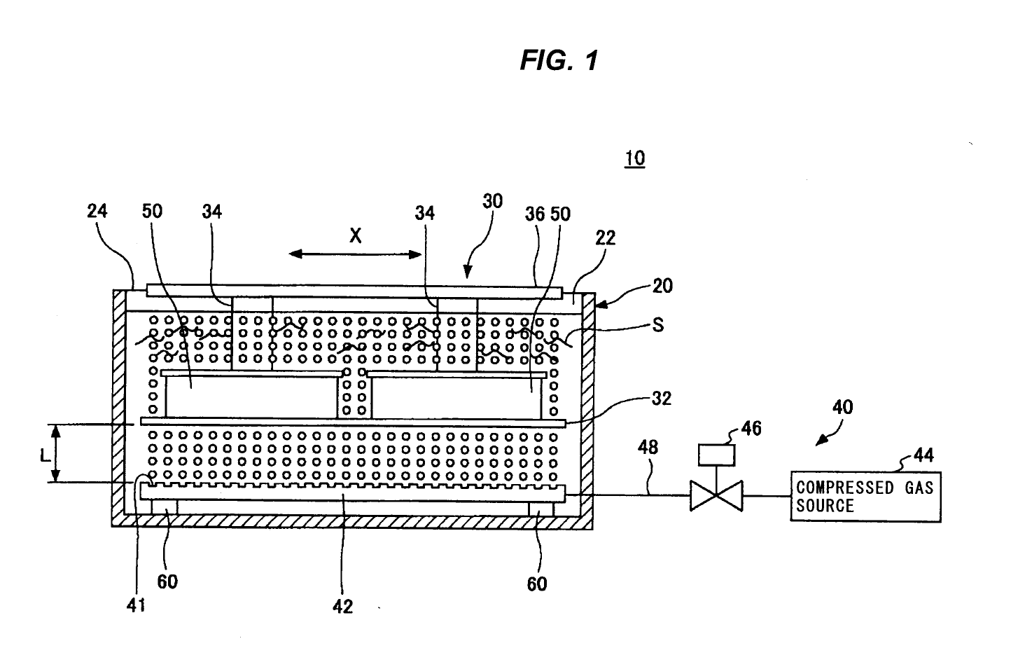

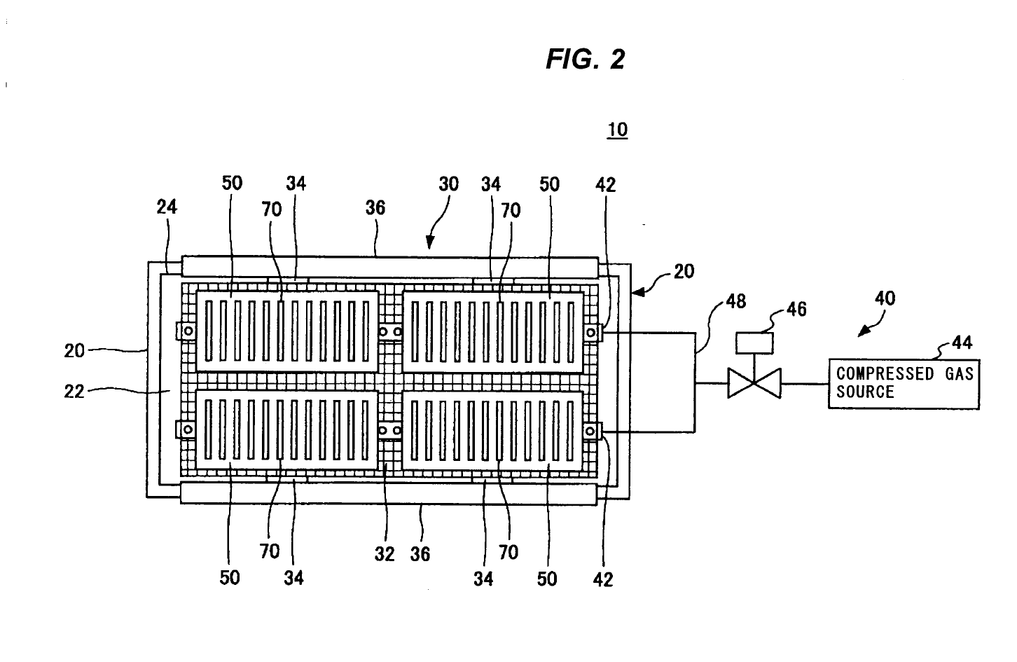

FIG. 1 is a schematic sectional view showing the configuration of Embodiment 1 of a glass substrate spacer separating apparatus according to the invention. FIG. 2 is a plan view of the glass substrate spacer separating apparatus shown in FIG. 1.

As is shown in FIGS. 1 and 2, a glass substrate spacer separating apparatus 10 includes a liquid tank 20, a cassette supporting mechanism 30 and a bubble generating mechanism 40. The liquid tank 20 has a rectangular parallelepiped box shape. The liquid tank 20 has an opening 22 at an upper side thereof. Service water or pure water or a liquid to which a surface-active agent, acid or alkali is added is stored in an interior of the liquid tank 20.

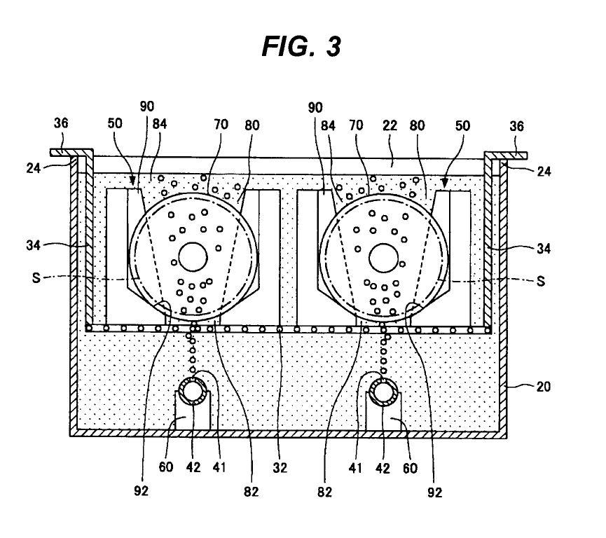

The cassette supporting mechanism 30 has a cassette resting portion 32 which is made up of a grid-like member and on which a plurality of (four in this embodiment) cassettes 50 are rested, suspending portions 34 which extend upwards (in a vertical direction) from both sides of the cassette resting portion 32 and sliding portions 36 which extend sideways (in a horizontal direction) from upper ends of the suspending portions 34. The sliding portions 36 are rested at an upper end portion 24 of the liquid tank 20 and are provided slidably along the upper end portion 24 of the liquid tank 20 in X directions (horizontal directions). In each cassette 50, substrate loading portions 80 (refer to FIG. 3) are aligned in a longitudinal direction, and glass substrates 70 with spacers attached thereto are loaded individually in their corresponding substrate loading portions 80.

Here, a manufacturing process for manufacturing glass substrates 70 will be described.

In a manufacturing process for manufacturing circular disc-shaped glass substrates 70, there is a machining process of machining planes and end faces of glass substrates 70 which includes a grinding/abrasion step. In this grinding/abrasion step, for example, as a method for enhancing the abrasion efficiency of end faces of glass substrates 70, a stacked body of glass substrates is prepared in which a plurality of (for example, some several hundreds) glass substrates 70 are stacked one on another via resin spacers S in a plane direction, and end faces of so many glass substrates 70 are ground or abraded at the same time.

On completion of the grinding/abrasion step of grinding or abrading the end faces of the stacked body of glass substrates, a glass substrate and spacer separating step is performed before the glass substrates 70 are transported to a subsequent step of grinding or abrading plane portions of the glass substrates 70. In this separating step, the glass substrates 70 are separated piece by piece from the stacked body of glass substrates, and following this, spacers S which are closely attached to main planes of the glass substrates 70 are separated piece by piece from the glass substrates 70.

In this embodiment, in order to implement the spacer separation with good efficiency, the glass substrates 70 with spacers in which the spacers S are closely attached to the main planes of the glass substrates 70 are loaded in substrate loading portions in the predetermined cassettes 50.

Each cassette 50 has a plurality of substrate loading portions 80 for loading glass substrates 70 with spacers. Each substrate loading portion 80 is adapted to load one glass substrate 70 with a spacer. Thus, in each cassette 50, a plurality of glass substrates 70 with spacers are aligned at predetermined intervals in such a state that the glass substrates 70 with spacers are loaded in their corresponding substrate loading portions 80 individually. Consequently, the respective glass substrates 70 with spacers are held in such a state that their respective main planes are spaced apart from each other at predetermined intervals by the glass substrates 70 with spacers being loaded in their corresponding loading portions 80 individually.

In this embodiment, the cassettes 50 which are supported on the cassette supporting mechanism 30 can be moved in the X directions (in the horizontal directions) in a reciprocating motion by moving manually the sliding portions 36 in the X directions. Alternatively, a configuration may be adopted in which the cassettes 50 supported on the cassette supporting mechanism 30 are moved by driving the sliding portions 36 in the X directions (in the horizontal directions) by an actuator such as an air cylinder.

The bubble generating mechanism 40 has a bubble generating unit 42 which is provided at a bottom portion of the liquid tank 20 and in which a plurality of bubble spouting holes 41 are provided through which bubbles are generated into the liquid, a compressed gas source 44 which is provided outside the liquid tank 20 for supplying a compressed gas to the bubble generating unit 42, a pressure regulator valve 46 for regulating a pressure of the compressed gas supplied from the compressed gas source 44 to a predetermined pressure and a connection pipe 48 through which the compressed gas whose pressure is regulated by the pressure regulator valve 46 is supplied to the bubble generating unit 42.

The bubble generating unit 42 is made up of a cylindrical hollow tube, for example. The plurality of bubble spouting holes 41 are provided in a line, and the spouting holes 41 penetrate the bubble generating unit 42 from an inner circumference to an outer circumference thereof. An opening diameter of the bubble spouting hole 41 ranges from 0.2 mm to 2.0 mm. The opening diameter of the bubble spouting hole 41 preferably ranges from 0.5 to 1.5 mm and further preferably ranges from 0.7 to 1.3 mm. The plurality of bubble spouting holes 41 may be provided at random or in a zigzag fashion on an upper side of the hollow member.

The bubble generating unit 42 is supported at a predetermined height by means of height adjusting portions 60 which are fixed to the bottom portion of the liquid tank 20 so as to extend in the X direction (in the horizontal direction). Since the height adjusting portions 60 can be replaced by height adjusting portions 60 of arbitrary heights selectively, a distance L defined between the plurality of bubble spouting holes 41 which are disposed on the upper side of the bubble generating unit 42 and the cassettes 50 which are supported on the cassette supporting mechanism 30 can be set to a predetermined distance (for example, 10 mm to 100 mm).

In this embodiment, two bubble generating units 42 are arranged in parallel at the bottom portion of the liquid tank 20, and each bubble generating unit 42 is connected to the pressure regulator valve 46 and the compressed gas source 44 via the connection pipe 48. The number of bubble generating units 42 which are to be disposed in the liquid tank 20 is not limited to two, and hence, three or more bubble generating units may be provided. A configuration may be adopted in which the bubble generating units 42 are disposed in parallel below the cassettes 50. Alternatively, the bubble generating units 42 may be disposed obliquely to the direction in which the cassettes 50 extend by being inclined at a predetermined angle in a vertical direction.

The compressed gas source 44 includes an air compressor for producing compressed air and a tank for storing compressed air so produced, for example. The pressure regulator valve 46 is provided along the length of the connection pipe 48 which connects the bubble generating units 42 and the compressed gas source 44 for regulating a supply pressure at which the compressed air is supplied via the connection pipe 48 by changing its valve opening.

The pressure regulator valve 46 is designed to automatically regulating its valve opening so as to hold a preset supply pressure (for example, 5 kg/cm²). The pressure regulator valve 46 regulates the supply pressure of compressed air so that the size of bubbles spouted from the plurality of bubble spouting holes 41 in the bubble generating units 42 becomes a predetermined size (for example, of the order of 1 mm to 2 mm).

Bubbles generated from the plurality of bubble spouting holes 41 which are formed on the upper side of the bubble generating units 42 are spouted towards interiors of the cassettes 50 which are disposed thereabove and rise by virtue of buoyancy so as to be brought into contact with the plurality of glass substrates 70 which are loaded in the cassettes 50 and surfaces of the resin spacers S which are closely attached to the main planes of the glass substrates 70, whereby the resin spacers S can be separated from their corresponding glass substrates 70 by making use of the buoyancy of bubbles.

Here, the function of bubbles spouted into the liquid by the bubble generating mechanism 40 will be described.

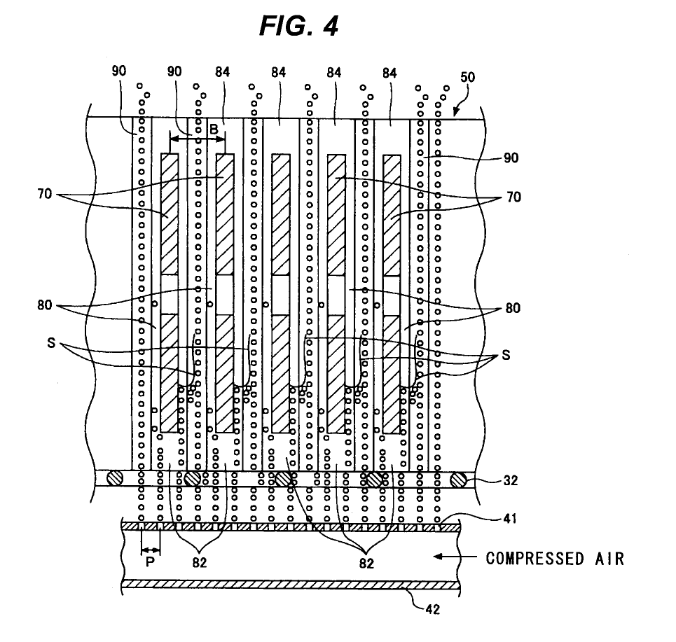

FIG. 3 is a vertical sectional view, as viewed sideways, of the liquid tank 20 showing an interior configuration thereof. FIG. 4 is a vertical sectional view, as viewed from the front, of an interior of the cassette 50. As is shown in FIGS. 3 and 4, the plurality of substrate loading portions 80 are aligned in the interior of the cassette 50. Partitions 90 are formed on both sides of each substrate loading portion 80 in a laterally symmetrical fashion. An inclined step portion 92 is formed on each partition 90 so that an outer circumference of the glass substrate 70 is brought into abutment therewith. Further, each substrate loading portion 80 has a lower opening 82 which is opened downwards and an upper opening 84 which is opened upwards.

The respective lower openings 82 of the substrate loading portions 80 form a bubble inlet port which extends in the X direction so as to confront the bubble generating unit 42. The cassette supporting mechanism 30 which supports the cassettes 50 is configured so that the cassette resting portion 32, which is formed by causing wires extending in the X and Y directions to intersect each other, is suspended by the suspending portions 34 which are disposed on both sides of the cassette resting portion 32. The cassette resting portion 32 is disposed so that bubbles spouted from the plurality of bubble spouting holes 41 in the bubble generating units 42 pass through openings defined between the wires forming the cassette resting portion 32 so as to flow into the respective lower openings 82 of the substrate loading portions 80. The cassette resting portion 32 maybe formed by other materials than the wires such as rods or plates which are placed laterally.

The resin spacers S (indicated by an alternate long and short dash line in FIG. 3) are closely attached to the main planes of the glass substrates 70 which are loaded individually in their corresponding substrate loading portions 80. Note that the resin spacer S is formed of a material whose specific gravity is lighter than that of the liquid stored in the liquid tank 20.

When compressed air whose pressure is regulated by the pressure regulator valve 46 is supplied to the bubble generating units 42, bubbles are spouted upwards from the plurality of bubble spouting holes 41 in the bubble generating units 42. Intervals P at which the bubble spouting holes 41 are aligned in the X direction are set to be 0.2 to 2 times larger than intervals B at which the glass substrates 70 are loaded in the cassettes 50. Bubbles spouted from the plurality of bubble spouting holes 41 continue to flow into the lower openings 82 of the cassettes 50 which are disposed thereabove and rise in the respective substrate loading portions 80 to reach a liquid surface lying above the upper openings 84.

Consequently, groups of bubbles which flow into the substrate loading portions 80 from their lower openings 82 come into contact with the spacers S which are closely attached to the main planes of the glass substrates 70 loaded individually in the substrate loading portions 80, whereby lower edge portions of the spacers S are turned upwards. The sliding portions 36 are caused to reciprocate in the X directions along the upper end portion 24 of the liquid tank 20 at the same time as bubbles are spouted. By doing so, the cassettes 50 rested on the cassette resting portion 32 are moved in the X directions in the liquid tank 20 so that bubbles come into contact with the spacers S in a uniform fashion in the respective interiors of the cassettes 50.

As is shown in FIG. 4, lower end portions of the spacers S which are separated from the main planes of the glass substrates 70 are curved into a U-like shape to project from the glass substrates 70 so as to close bubble rising passages, whereby the lower end portions so curved function to increase surface areas with which bubbles come into collision. Because of this, when part of the spaces S are turned up from lower sides of the main planes of the glass substrates 70 as a result of the contact of bubbles with the spacers S, the contact areas of bubbles with the spacers S are gradually increased thereafter, whereby a force which pulls the spacers S upwards is increased.

In this way, the respective spacers S which are closely attached to the glass substrates 70 can be separated almost simultaneously in the process of groups of bubbles spouted from the bubble spouting holes 41 in the bubble generating units 42 rising to pass through the respective substrate loading portions 80. Thus, the spacers S can be separated from all the glass substrates 70 loaded in the cassettes 50 within a short period of time. By the operator moving the cassette supporting mechanism 30 in the X directions, liquid resistance is imparted to the spacers S, whereby the separation of the individual spacers S which have started to be separated from the corresponding glass substrates 70 as a result of contact with bubbles from the glass substrates 70 is promoted further by the liquid resistance and the action of the bubbles.

Since their specific gravity is lighter than that of water, the spacers S which are separated from the glass substrates 70 are allowed to float in proximity to the liquid surface of the liquid tank 20. Thus, the operator can easily collect the spacers S.

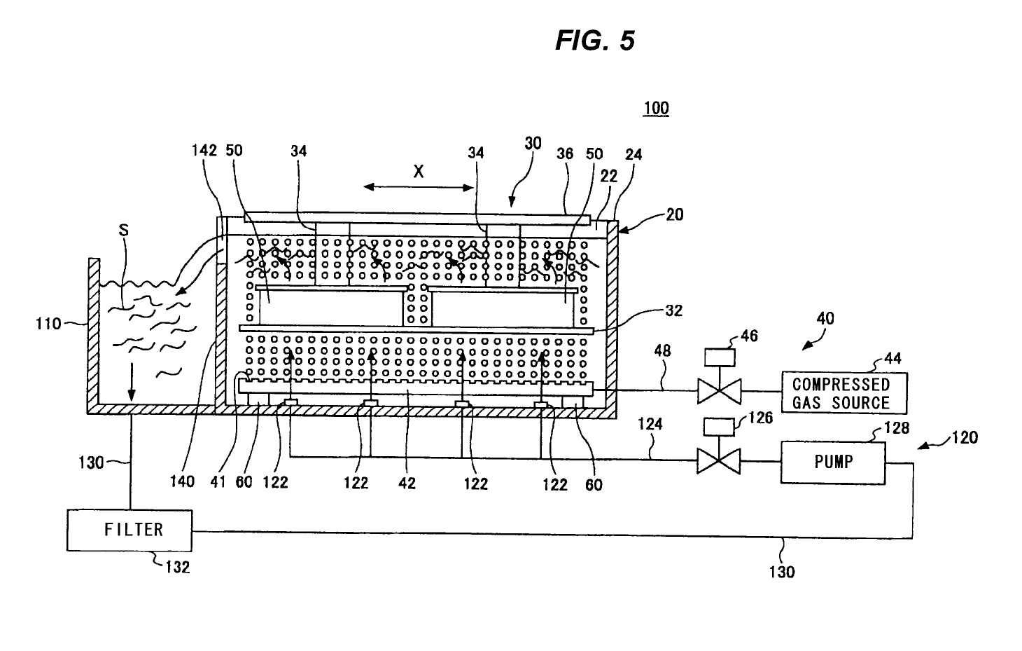

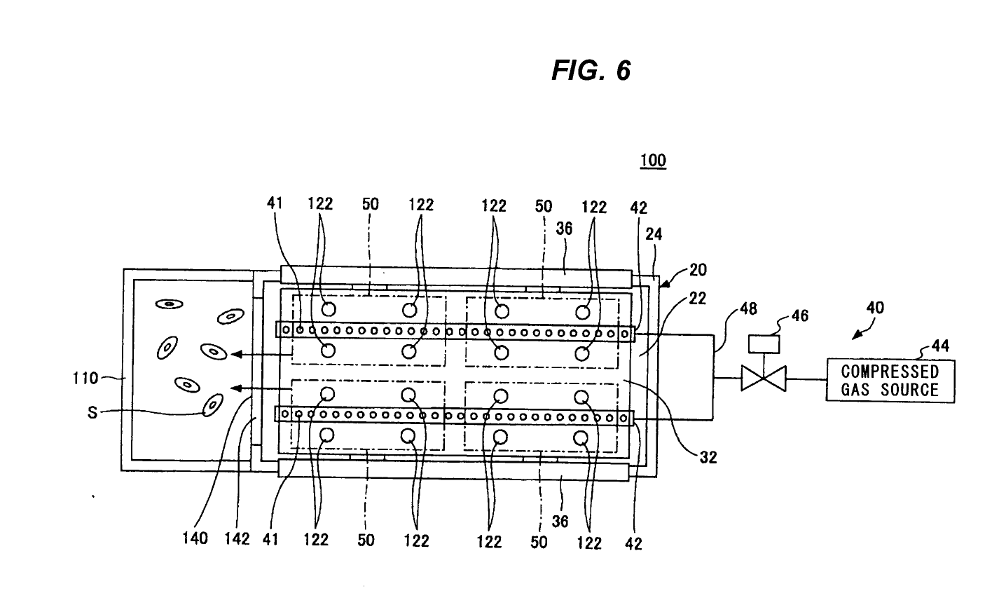

FIG. 5 is a schematic sectional view showing the configuration of Modified Example 1 of a glass substrate spacer separating apparatus according to the invention. FIG. 6 is a plan view of the glass substrate spacer separating apparatus shown in FIG. 5. Note that in FIG. 6, the configuration of a cassette resting portion 32 is omitted from illustration in order to make clear constituent portions which are disposed below the cassette resting portion 32.

As is shown in FIGS. 5 and 6, a glass substrate spacer separating apparatus 100 according to Modified Example 1 of the invention has a liquid tank 20, a cassette supporting mechanism 30 and a bubble generating mechanism 40, which are like to those described in Embodiment 1 above, as well as a collecting tank 110. The collecting tank 110 is provided on a left-hand side of the liquid tank 20 for collecting spacers S which are separated from glass substrates 70 together with liquid that overflows from the liquid tank 20. Note that the collecting tank 110 may be provided in an interior of the liquid tank 20 or may be provided adjacent to an outside of the liquid tank 20.

In addition, a liquid supply mechanism 120 is provided in the liquid tank 20. The liquid supply mechanism 120 has a plurality of water current generating nozzles 122, a water supply pipe 124, a water pressure regulator valve 126, a pump 128, a drain pipe 130, and a filter 132. The water current generating nozzles 122 are provided at a bottom portion of the liquid tank 20 for spouting water currents towards cassettes 50 lying thereabove. The water supply pipe 124 is connected to the water current generating nozzles 122 at points along the length thereof and is connected to a discharge port of the pump 128 at the other end thereof. The water pressure regulator valve 126 is provided in a position along the length of the water supply pipe 124 for regulating a pressure of water discharged from the pump 128 to a preset pressure. The pump 128 is preferably actuated to operate while being linked with the compressed gas source 44 of the bubble generating mechanism 40 and is switched on and off to generate water currents at the same time as bubbles are generated in the liquid tank 20. Note that the pump 128 may not be linked with the bubble generating mechanism 40. Instead, the pump 128 may be actuated to operate periodically at predetermined time intervals. Alternatively, the pump 128 can be actuated to operate as required depending upon the separating conditions of the spacers S.

The drain pipe 130 is connected to a bottom portion of the collecting tank 110 at one end and is connected to a suction port of the pump 128 at the other end thereof. The filter 132 is provided in a position along the length of the drain pipe 130 for removing foreign matters contained in the liquid discharged.

When the pump 128 is actuated, liquid of the collecting tank 110 is discharged from the bottom portion via the drain pipe 130, foreign matters contained in the liquid so discharged are filtered out by the filter 132, and only the liquid from which the foreign matters are removed is sucked into the pump 128 via the suction port thereof. Further, pressurized water is discharged from the discharge port of the pump 128, and liquid whose pressure is regulated by the water pressure regulator valve 126 is spouted from the plurality of water current generating nozzles 122 towards the cassettes 50. By doing this, bubbles from a plurality of bubble spouting holes 41 of bubble generating units 42 and water currents from the water current generating nozzles 122 are forcibly emitted into respective substrate loading portions 80 in interiors of the cassettes 50 from bottom to top thereof.

Because of this, groups of bubbles and water currents flow into respective substrate loading portions 80 of the cassettes 50 from lower openings 82 thereof so that spacers S closely attached to the glass substrates 70 loaded individually in the corresponding substrate loading portions 80 can be separated altogether from the corresponding glass substrates 70 with good efficiency within a short period of time to float near the surface of liquid of the liquid tank 20.

A recess portion 142 is provided at an upper end of wall portion 140 which defines a boundary between the collecting tank 110 and the liquid tank 20. Since the recess portion 142 is provided in a position which is lower in level than the liquid surface of the liquid tank 20, the spacers S floating near the liquid surface of the liquid tank 20 are discharged into the collecting tank 110 together with liquid that flows out of the liquid tank 20 to the collecting tank 110 side. Then, the spacers S separated from the glass substrates 70 are light in specific gravity than water, the spacers S are floating near the surface of liquid of the collecting tank 110. Thus, the operator can collect the spacers S with ease.

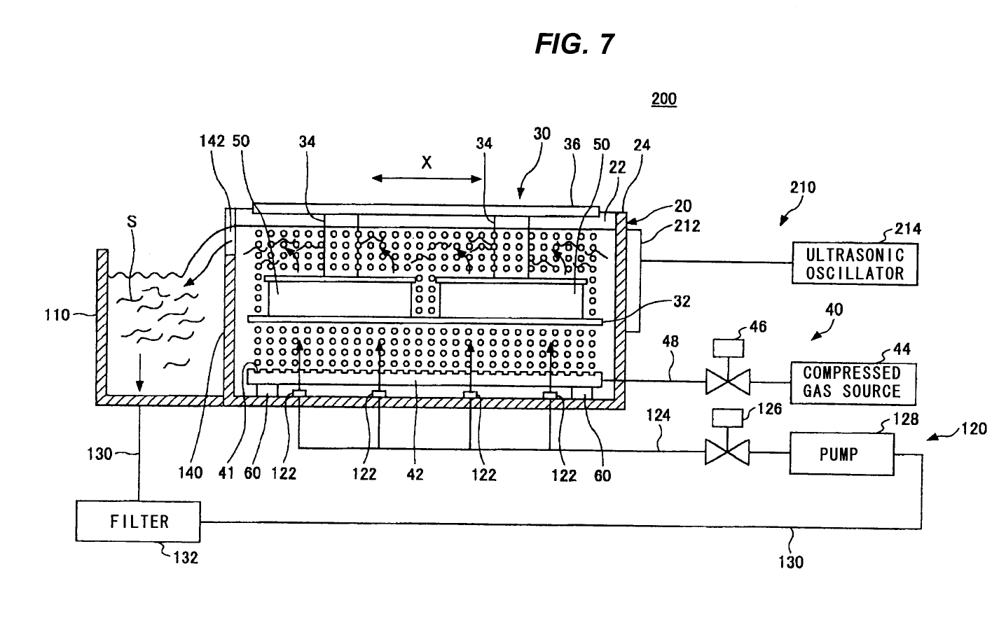

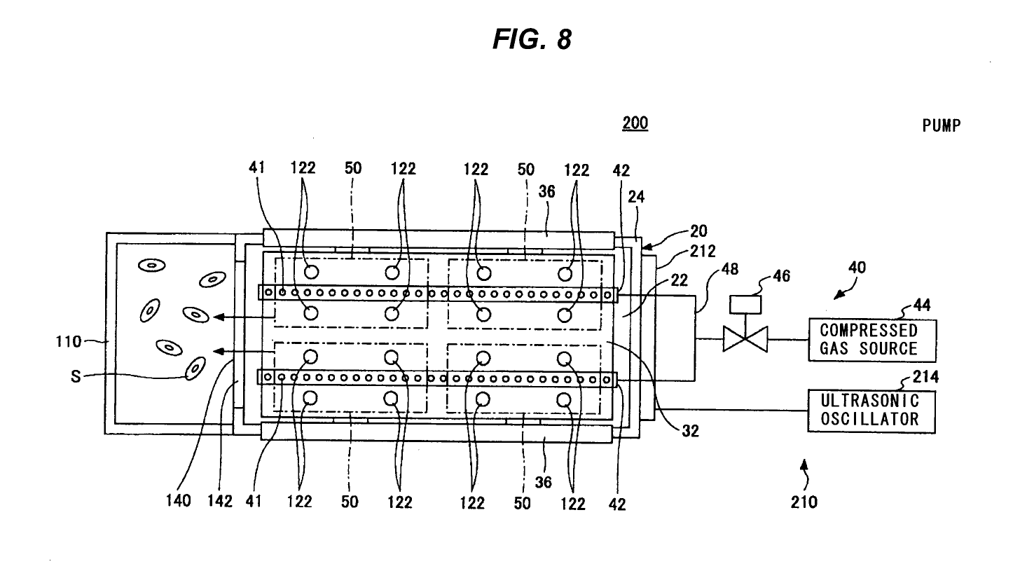

FIG. 7 is a schematic sectional view showing the configuration of Modified Example 2 of a glass substrate spacer separating apparatus according to the invention. FIG. 8 is a plan view of the glass substrate spacer separating apparatus shown in FIG. 7. In FIG. 8, the configuration of a cassette resting portion 32 is omitted from illustration in order to make clear constituent portions which are disposed below the cassette resting portion 32.

As is shown in FIGS. 7 and 8, a glass substrate spacer separating apparatus 200 according to Modified Example 2 of the invention has a liquid tank 20, a cassette supporting mechanism 30, a bubble generating mechanism 40, a collecting tank 110 and a liquid supply mechanism 120, as well as a vibration mechanism 210.

The vibration mechanism 210 is made up of a vibration plate 212 closely attached to a lateral side of the liquid tank 20 and an ultrasonic oscillator 214 for inputting a vibration signal for generating ultrasonic waves into the vibration plate 212. The vibration plate 212 vibrates by receiving a vibration signal from the ultrasonic oscillator 214 to propagate ultrasonic waves to a liquid of the liquid tank 20 via the liquid tank 20. Since ultrasonic waves are propagated to cassettes 50 which are submerged in the liquid of the liquid tank 20 via the liquid, glass substrates 70 which are loaded individually in corresponding substrate loading portions 80 vibrate.

The attaching position of the vibration plate 212 is not limited to the lateral side of the liquid tank. For example, the vibration plate 212 may be attached to a lower side of the liquid tank 20. Additionally, instead of being provided on the outside of the liquid tank 20, a configuration may be adopted in which the vibration plate 212 is provided on an inner wall of the liquid tank 20. Alternatively, a vibration member able to be placed in liquid may be submerged in the liquid stored in the liquid tank 20 in place of the vibration plate 212.

The ultrasonic oscillator 214 is preferably actuated to operate while being linked with a compressed gas source 44 of the bubble generating mechanism 40 and a pump 128 of the liquid supply mechanism 120 and is switched on and off to generate vibrations at the same time as bubbles are generated in the liquid tank 20. Note that the ultrasonic oscillator 214 may not be linked with the compressed gas source of the bubble generating mechanism 40 and the pump 128 of the liquid supply mechanism 120. Instead, the ultrasonic oscillator 214 may be actuated to operate periodically at predetermined time intervals. Alternatively, the ultrasonic oscillator 214 can be actuated to operate as required depending upon the separating conditions of the spacers S.

Because of this, when the pump 128 is actuated, liquid whose pressure is regulated by a water pressure regulator 126 is spouted towards the cassettes 50 from a plurality of current generating nozzles 122, and the vibration plate 212 vibrates by a vibration signal from the ultrasonic oscillator 214 so as to propagate ultrasonic waves to the right lateral side of the liquid tank 20. Then, bubbles from a plurality of bubble spouting holes 41 in bubble generating units 42 and water currents from the water current generating nozzles 122 are forcibly emitted into respective substrate loading portions 80 in interiors of the cassettes 50 from bottom to top thereof.

By doing this, since the water currents containing mixed bubbles and vibrations in the form of ultrasonic waves are propagated to the respective glass substrates 70 loaded individually in the corresponding substrate loading portions 80, spacers S closely attached to the glass substrates 70 can be separated altogether from the glass substrates 70 within a short period of time so as to allow them to float near the liquid surface of the liquid tank 20.

Then, the spacers S floating near the liquid surface of the liquid tank 20 are discharged into the collecting tank 110 together with liquid which flows out of the liquid tank 20 towards the collecting tank 110 side and float near the surface of liquid of the collecting tank 110. Because of this, the operator can collect the spacers S floating near the liquid surface of the collecting tank 110 with ease. The generation of bubbles and water currents by the bubble generating mechanism 40 and the liquid supply mechanism 120 and the propagation of ultrasonic waves by the vibration plate 212 may be caused to occur at the same time or the individual mechanisms maybe designed to be actuated arbitrarily at different points in time. Alternatively, the individual mechanisms can be combined selectively for operation.

In Modified Example 2, a configuration may be adopted in which the liquid supply mechanism 120 is removed. As this occurs, bubbles from the plurality of bubble spouting holes 41 in the bubble generating units 42 are forcibly emitted into the respective substrate loading portions 80 in the interiors of the cassettes 50, and additionally vibrations in the form of ultrasonic waves are propagated to the substrate loading portions 80, thereby making it possible to promote the separation of the spacers S.

In general, a manufacturing process for manufacturing a glass substrate for a magnetic recording medium and a magnetic disk involves the following steps.

(1) A glass substrate stock formed through a floating method, a fusion method or a press molding method is machined into a disk (a circular disk) shape, and thereafter, an inner peripheral end surface and an outer peripheral end surface of the disk are chamfered. (2) Upper and lower main planes of the glass substrate are ground. (3) Inner and outer peripheral end surfaces and the inner and outer peripheral chamfered surfaces are end abraded. (4) The upper and lower main planes of the glass substrate are abraded. The abrading step may involve a primary abrasion or both a primary abrasion and a secondary abrasion (an abrasion in which abrasive grains are used which are finer than abrasive grains used in the primary abrasion) with a tertiary abrasion performed arbitrarily after the secondary abrasion (an abrasion in which abrasive grains are used which are finer than abrasive grains used in the secondary abrasion). (5) The glass substrate is precision washed to obtain a glass substrate for a magnetic recording medium. (6) A film such as a magnetic layer is formed on the glass substrate for a magnetic recording medium, whereby a magnetic disk is manufactured.

In the manufacturing process for manufacturing a glass substrate for a magnetic recording medium and a magnetic disk, the glass substrate may be washed between the individual steps (an inter-step washing), and surfaces of the glass substrate may be etched between the individual steps (an inter-step etching). Further, in the event that a high mechanical strength is required for a glass substrate for a magnetic recording medium, a reinforcement step (for example, a chemical reinforcement step) of forming a reinforcement layer on a surface layer of the glass substrate may be performed before the abrasion step or after the abrasion step or between abrasion steps.

In the invention, the glass substrate for a magnetic recording medium may be an amorphous glass or a crystallized glass or a reinforced glass having a reinforcement layer on the surface layer of the glass substrate (for example, a chemically reinforced glass). In addition, the glass substrate stock for the glass substrate of the invention may be such as to be formed through the floating method, the fusion method or the press molding method.

The invention relates to the step (3) in which the inner and outer peripheral end surfaces and the inner and outer peripheral chamfered surfaces are end abraded and relates to the spacer separation step in which the stacked body of glass substrates for magnetic recording media is prepared, the end portions of the glass substrates of the stacked body of glass substrates are abraded and thereafter the glass substrates are separated from the stacked body of glass substrates, and the spacers adhering to the main planes of the glass substrates are separated from the glass substrates.

While the embodiment is described as the four cassettes 50 being submerged in the liquid of the liquid tank 20, the invention is not limited thereto. Hence, four or more cassettes 50 may be submerged in the liquid of the liquid tank 20.

In addition, while the embodiment is described as the two bubble generating units 42 being provided at the bottom portion of the liquid tank 20, the invention is not limited thereto. Hence, the number of bubble generating units may be increased as required to match the number of cassettes 50.

Additionally, while the embodiment is described as the bubble generating unit 42 being formed by arranging the bubble spouting holes 41 in the line in the hollow tube, the invention is not limited thereto. For example, a plurality of bubble generating nozzles may be arranged at the bottom portion of the liquid tank 20. Alternatively, a configuration in which a plurality of bubble spouting holes are arranged in an upper side of a hollow flat plate-like member may be adopted as the bubble generating unit 42.

What is claimed is:

1. A glass substrate spacer separating apparatus comprising:
a cassette adapted to load a plurality of glass substrates with spacers attached thereto in such a state that the plurality of glass substrates are separated piece by piece;
a liquid tank adapted to store a liquid in which the cassette is to be submerged; and
a bubble generating mechanism configured to generate bubbles which move towards an interior of the cassette which is submerged in the liquid of the liquid tank, wherein
the spacers are separated individually from the plurality of glass substrates to which the spacers are attached by bringing the bubbles generated from the bubble generating mechanism into contact with surfaces of the plurality of glass substrates with spacers attached thereto which are loaded in the cassette in the liquid of the liquid tank.

2. The glass substrate spacer separating apparatus as set forth in claim 1, wherein
the liquid tank has a moving mechanism for moving the cassette so as to change a relative position of the cassette to the bubble generating mechanism.

3. The glass substrate spacer separating apparatus as set forth in claim 1, wherein
the forth bubble generating mechanism includes:
a bubble generating unit which is provided at a bottom portion of the liquid tank and in which a plurality of holes are provided for generating bubbles in the liquid;
a compressed gas source which is provided outside of the liquid tank, the compressed gas source being configured to supply a compressed gas to the bubble generating unit;
a pressure regulator valve configured to regulate a pressure of the compressed gas supplied from the compressed gas supply source to a predetermined pressure; and
a connection pipe configured to supply the compressed gas whose pressure is regulated by the pressure regulator valve to the bubble generating unit.

4. The glass substrate spacer separating apparatus as set forth in claim 3, wherein
the bubble generating unit includes a plurality of holes whose opening diameter ranges from 0.2 mm to 2.0 mm on a surface of a tube or a flat plate.

5. The glass substrate spacer separating apparatus as set forth in claim 3, wherein
the holes are formed at intervals which are 0.2 to 2 times larger than glass substrate loading intervals at which the glass substrates with spacers attached thereto are loaded in the cassette in such a state that the glass substrates with spacers attached thereto are separated piece by piece.

6. The glass substrate spacer separating apparatus as set forth in claim 1, further comprising:
a separate liquid tank provided inside or outside the liquid tank, the separate liquid tank being collect the spacers separated from the glass substrates in the liquid tank, and
a liquid supply mechanism configured to supply a liquid so that the liquid of the liquid tank overflows into the separate liquid tank, wherein
the spacers separated in the liquid tank are caused to move into the separate liquid tank together with the liquid which overflows from the liquid tank for collecting thereof.

7. The glass substrate spacer separating apparatus as set forth in claim 1, wherein
the liquid tank includes an ultrasonic wave radiating mechanism configured to radiate ultrasonic waves to the glass substrates with spacers attached thereto which are loaded in the cassette which is submerged in the liquid.

8. A glass substrate manufacturing method comprising:
preparing a stacked body of glass substrates in which pluralities of glass substrates and spacers are stacked alternately one on another and abrading peripheral end surfaces of the glass substrates of the stacked body of glass substrates;
separating the glass substrates from the stacked body of glass substrates after the abrasion of the peripheral end surface of the glass substrates has been performed; and
separating the spacers adhering to main planes of the glass substrates from the glass substrates, wherein
the glass substrate spacer separating apparatus set forth under any of claims 1 to 7 is used to separate the spacers from the glass substrates in the separating of the spacers.

9. The glass substrate manufacturing method as set forth in claim 8, wherein
the spacers are formed of a material whose specific gravity is lighter than that of the liquid stored in the liquid tank.

10. The glass substrate manufacturing method as set forth in claim 8, wherein
the glass substrates are glass substrates for magnetic recording media.
